(19) United States
(12) Patent Application Publication
(10) Pub. No.: US 2023/0166473 A1
(43) Pub. Date: Jun. 1, 2023

(54) CAGE OPENING ASSISTANT

(71) Applicant: Haarslev Industries A/S, Sonderso (DK)

(72) Inventors: Anders SVEHAG, Sonderso (DK); Bjarne GRØNBECH, Sonderso (DK); Thoke Sandager THAYSEN, Sonderso (DK)

(21) Appl. No.: 18/070,262

(22) Filed: Nov. 28, 2022

(30) Foreign Application Priority Data
Nov. 29, 2021 (DK) PA 2021 01129

(51) Int. Cl. B30B 15/00; B30B 9/14

(52) U.S. Cl. CPC B30B 15/0082; B30B 9/14

(57) ABSTRACT

The present invention relates to a screw press comprising a press chamber comprising a screw and surrounded by a cage, wherein the screw comprising a shaft having a helical structure on the outside of the shaft, and wherein the cage is provided with at least two cage elements, wherein at least one cage element of the at least two cage elements comprises a pivotable connection allowing the at least one cage element to pivot, wherein a screw press is provided with a cage open assistant, assisting the at least one cage element to pivot.

### TECHNICAL FIELD OF THE INVENTION

The present invention relates to an improved screw press. In particular the present invention relates to an improved screw press where handling of the cage are improved and access to the inlays, press chamber and the screw are improved resulting in a maintained high productivity.

### BACKGROUND OF THE INVENTION

Various techniques are used for separating liquids from solids, including pressing and centrifugation. Pressing may be a preferred technology for large volumes of low value products where the separation of liquids from solids may be more effective for the pressing technology as is the productivity, whereas centrifugation may be harsh on the product and not as productive as the pressing technology.

The liquid removed may be water, as it may be relevant to reduce the water content of a product before drying and because it may be desirable to collect the liquid material as a separate fraction as an added value product. The liquid may also be an oil or a fat product, where preferably a dried starting material may be subjected to pressing, resulting in a fat/oil fraction and a “de-fatted” solid fraction.

Thus, it may be desirably to remove or extract fats and oils from products, such as from cooked and dried animal and poultry by-products, either because the fats and oils may have a negative effect on taste, stability, appearance of a food or feed product, or extraction of the fat or oil may have a desired nutritional value.

The extracted oils and fats may be used as a nutritional ingredient, as a constituent a non-consumable product, or e.g. in a biofuel product. Therefore, the production of high value fat or oil products may be of high interest.

Fats are considered triglycerides that are solid or semi-solid at room temperature, whereas oils are also triglycerides, however, triglycerides that are liquid or clear liquid at room temperature. The fats comprise mainly saturated fatty acids whereas as the oils mainly comprises monosaturated or polyunsaturated fatty acid.

Extraction of the fats or oils may be mechanically or chemically, however, mechanically process may be preferred since the mechanical process are faster, simpler and cheaper. Furthermore, the mechanical process does not have chemical influence on the final fat product or oil product that also needs to be considered or handled.

Mechanical extraction of fats or oils may include a screw press comprising a screw and a cage. The screw comprises a helical structure surrounding a rotatable shaft. The screw is surrounded by a cage comprising a perforated housing allowing the fat or oil to leave the material to be pressed. On the inside of the cage a multiplicity of inlays are placed having a short distance between the inlays, allowing the liquid, e.g. the fat and oil, to escape the press chamber and retaining the solid or fines of the solid within the press chamber, until the solids reach the press chamber exit.

WO 1983/00306 describes a screw press and a method for inspecting the screw press. The screw press comprising a press chamber comprising a screw (a rotatable shaft) surrounded by a cage. The rotatable shaft having a helical structure on the outside of the rotatable shaft. The cage is provided with at least two cage elements, wherein at least one cage element of the at least two cage elements comprise a pivotable connection allowing the at least one cage element to pivot.

The challenge with the screw presses available today is that the access during maintenance and inspection of the cage, the screw, and the inlays of the screw press may be time consuming and difficult. Furthermore, the cage, or the cage elements, making up the cage, may be so large and heavy that a hoist system may be installed at the time of maintenance.

Thus, traditionally inspection and maintenance may be very time consuming, difficult and expensive, and something inspection and maintenance may be postponed because of the difficult procedure until absolutely necessary, which may influence the efficiency and productivity of the screw press.

Hence, there is a need in the industry for a screw press, in particular a fat screw press, where access to the cage and the press chamber may be easy, and/or quick, where the disassembling of the screw press, and the cage, is reduced, or even avoided, and whereby productivity of the screw press may be improved.

### SUMMARY OF THE INVENTION

Thus, an object of the present invention relates to a screw press having an improved productivity or which has maintained a high productivity.

In particular, it is an object of the present invention to provide a screw press that solves the above mentioned problems of the prior art with a slow, difficult and expensive maintenance, often leading to low or reduced efficiency and productivity of the screw press.

Thus, one aspect of the invention relates to a screw press comprising a press chamber comprising a screw and surrounded by a cage, wherein the screw comprising a rotatable shaft having a helical structure on the outside of the rotatable shaft, and wherein the cage is provided with at least two cage elements, wherein at least one cage element of the at least two cage elements comprises a pivotable connection allowing the at least one cage element to pivot, wherein a screw press is provided with a cage open assistant, assisting the at least one cage element to pivot.

A further aspect relates to a screw press comprising a press chamber comprising a screw and surrounded by a cage, wherein the screw comprising a rotatable shaft having a helical structure on the outside of the rotatable shaft, and wherein the cage is provided with at least two cage elements, wherein at least one cage element of the at least two cage elements comprises a pivotable connection allowing the at least one cage element to pivot, wherein a screw press is provided with at least 2 beams centrally placed above the press chamber.

Another aspect of the present invention relates to the use of the screw press according to the present invention, for the separation of a liquid from a solid of a starting material.

Yet another aspect of the present invention relates to a method of inspecting the screw press according to the present invention, the method comprising the steps of:

(i) removing a first cassis side;

(ii) attaching a first fastening means of a cage open assistant to a second fastening means of a cage element;

(iii) activating the cage open assistant opening the cage element providing access to a press chamber and a screw of the screw press;

(iv) subjecting the cage to the required maintenance; and

(v) activating the cage open assistant and closing the cage element.

(vi) optionally, repeating steps (i)-(v) with a further cage element.

### BRIEF DESCRIPTION OF THE FIGURES

FIG. 1 shows a screw press according to the present invention,

FIG. 2 shows the screw press as demonstrated in FIG. 1, where part of the chassis surrounding the screw press has been removed to show the inside of the screw press and a supporting device for stabilizing the screw press.,

FIG. 3 shows the cage element of the screw press demonstrated in FIG. 1 and FIG. 2, and where the inlays are placed on the inside of the cage elements,

FIG. 4 shows a more open view of the cage demonstrated in FIG. 3.

FIG. 5 shows the cage open assistant as according to the present invention integrated into the supporting device of the screw press as demonstrated in FIG. 1 or FIG. 2 and attached to the beams (comprising two beams placed centrally over the press centre) of the supporting device.

FIG. 6 shows a screw press as demonstrated in FIG. 1 and FIG. 2, with an open cage element demonstrating the cage open assistant as integrated into the screw press and attached to the beams (comprising two beams placed centrally over the press centre) of the supporting device.

FIG. 7 shows a side-view of the screw press as demonstrated in FIG. 1 and FIG. 2 with an open cage element using a cage open assistant as according to the present invention integrated into the screw press and attached to the beams (comprising two beams placed centrally over the press centre) of the supporting device.

The present invention will now be described in more detail in the following.

### DETAILED DESCRIPTION OF THE INVENTION

Accordingly, the inventors of the present invention found that the conventional methods of opening the cage elements, by building an external cage open assistant which is removed after maintenance, was too complicated, time consuming and expensive and a new solution is necessary.

A preferred embodiment of the present invention relates to a screw press comprising a press chamber comprising a screw and surrounded by a cage, wherein the screw comprising a rotatable shaft having a helical structure on the outside of the rotatable shaft, and wherein the cage is provided with at least two cage elements, wherein at least one cage element of the at least two cage elements comprises a pivotable connection allowing the at least one cage element to pivot, wherein a screw press is provided with a cage open assistant, assisting the at least one cage element to pivot.

In a preferred embodiment of the present invention the screw press comprising a press chamber comprising a screw and surrounded by a cage, wherein the screw comprising a rotatable shaft having a helical structure on the outside of the rotatable shaft, and wherein the cage comprises two cage elements, wherein at least one cage element, preferably both of the two cage elements, comprises a pivotable connection allowing the at least one cage element, preferably the two cage elements, to pivot, wherein a screw press is provided with a cage open assistant, assisting the at least one cage element, preferably both of the two cage elements, to pivot.

Preferably, the two cage elements may be sequentially subjected to pivot. Thus, the first cage element may be opened, and when the first cage element has been closed again, the second cage element may be opened.

Alternatively, the sequentially opening of the cage elements may involve pivoting the first cage element to open the first cage element, followed by pivoting the second cage element to open the second cage element. When the cage elements are opened, maintenance, repairing or substitution of worn parts may be performed and then the first cage element and the second cage element may be closed again.

In a preferred embodiment of the present invention the cage open assistant may be used for opening both the first cage element and subsequently the second cage element, or vice versa.

Preferably, the cage comprises two cage elements.

In an embodiment of the present invention the two cage elements comprise two semi-cylindrical cage elements.

The term “cage” relates to a cage-like structure or framework in a screw press allowing liquids and/or small solids of a material to pass whereas larger solids are prevented from passing the cage-line framework.

In an embodiment of the present invention the cage may preferably be provided with 2 cage elements. The number of cage elements may be determined by the number of cage elements from a cross-sectional perspective of the screw press perpendicular to the longitudinal directed of the screw.

Preferably, the cage may comprise two semi-cylindrical cage elements, a first semi-cylindrical cage element and a second semi-cylindrical cage element.

Each cage element may comprise one or more longitudinal placed cage elements. The one or more cage longitudinal placed elements may be placed in extension of each other along the longitudinal direction of the screw.

In an embodiment of the present invention the two semi-cylindrical cage elements, i.e. the first semi-cylindrical cage element and the second semi-cylindrical cage element, may extend through the cage of the screw press, in the longitudinal direction relative to the longitudinal direction of the screw, as a single longitudinal placed semi-cylindrical cage element; as 2 longitudinal placed semi-cylindrical cage elements; as 3 longitudinal placed semi-cylindrical cage elements; as 4 longitudinal placed semi-cylindrical cage elements; as 5 longitudinal placed semi-cylindrical cage elements; as 6 longitudinal placed semi-cylindrical cage elements; as 7 longitudinal placed semi-cylindrical cage elements or more.

Preferably, the first semi-cylindrical cage element and the second semi-cylindrical cage element, may extend through the cage of the screw press, in the longitudinal direction relative to the longitudinal direction of the screw, as a single longitudinal placed semi-cylindrical cage element.

In an embodiment of the present invention, the single longitudinal placed semi-cylindrical cage element may be a one-piece semi-cylindrical cage element.

A screw press may comprise a press chamber with a cage, comprising one or more longitudinal placed semi-cylindrical cage elements. longitudinal placed semi-cylindrical cage elements are considered relative to the longitudinal direction relative to the screw.

The press chamber comprising the screw and encircled by the cage may be supported by a supporting device, which supports the screw press to the floor. This construction may preferably be surrounded by or packed in a chassis.

In an embodiment of the present invention the cage may be provided with a multiplicity of inlays facing and fully surrounding the screw, whereby a press chamber may be formed within the cage, between the inlays and the screw.

The inlays may preferably be in contact with the inside of the cage elements facing the screw.

The screw press may be provided with one or more beams placed horizontally and parallel to the longitudinal direction of the screw.

The beams may be used for fastening the cage and/or the cage elements and/or for the attachment of the chassis.

A preferred embodiment of the present invention relates to a screw press comprising a press chamber comprising a screw and surrounded by a cage, wherein the screw comprising a rotatable shaft having a helical structure on the outside of the rotatable shaft, and wherein the cage is provided with at least two cage elements, wherein at least one cage element of the at least two cage elements comprises a pivotable connection allowing the at least one cage element to pivot, wherein a screw press is provided with at least 2 beams centrally placed above the press chamber.

The cage open assistant of the present invention may preferably be placed between the at least 2 beams. Preferably, the cage open assistant of the present invention may be centrally placed between the at least 2 beams.

Centrally placed between the at least two beams a one or more rails may be placed. The rail may comprise a waist, or the like, to support the rotatable shaft, e.g. during removal of the rotatable shaft.

During service or maintenance, a traditional procedure involves the disassembling of the screw press where individual sides of the chassis are removed and placed on the floor next to the screw press. Alternatively, an external cage open assistant is build on the outsideof the screw press which is removed after maintenance has finished. The semi-cylindrical cage elements are opened, so that, the press chamber and the screw become accessible. Following disassembly of one of the semi-cylindrical cage elements, the semi-cylindrical cage element is placed on the floor or opened by the external cage open assistant and the worn parts, like the inlays can be exchanged. New inlays may be inserted into the semi-cylindrical cage element. The semi-cylindrical cage element remained in the press chamber can either be provided with new inlays once the screw is removed from the press chamber, or it may be opened by also attaching a cage open assistant on the other side of the screw press to open the other semi-cylindrical cage element. Only when semi-cylindrical cage elements are exposed or opened, the associated inlays can be changed. Semi-cylindrical cage elements or the screw placed on the floor during maintenance, may be returned when re-assembling the screw press.

This indicates that maintenance and change of worn parts of semi-cylindrical elements, like worn inlays, is associated with high technical complexity and requires trained technical staff, because the disassembly and re-assembly of the screw press may be highly complex, time consuming and expensive.

This complexity may also cause the serviceability or flexibility in maintenance very limited, resulting in reduced performance of the screw press.

Since the accessibility of the cage and the inlays is difficult, a complex disassembly of many components must take place, e.g. to change worn inlays, maintenance and periodic maintenance must be performed by a skilled staff, often staff from the manufacturer, to ensure correct disassembly and re-assembly of the screw press, causing increased down time and increased costs involved with the maintenance of the screw press.

The inventors of the present invention surprisingly found that by providing at least one of the cage elements with a pivotable connection and a cage open assistant as described in the present invention, inspection and maintenance of the cage, inlays and the screw may be easy and quick, and resulting in an improved productivity.

Thus, the screw press, may comprise the semi-cylindrical cage elements pivotably mounted via a hinge allowing the semi-cylindrical cage elements to swing making the screw and the filtration space accessible, enabling a simpler and more rapid maintenance of the screw press and facilitate, in particular, the easy exchange of inlays.

In an embodiment of the present invention the hinge may in one end be attached to the second flange of one cage element and in the other end be attached to (i) the second flange of another cage element; or (ii) to a beam, preferably centrally located underneath the cage; or (iii) a bracket, preferably a bracket located below the cage.

Even maintenance may be performed faster and easier by implementing pivotable cage elements, the inventors found that handling of the pivotable cage elements may be difficult because of the weight of the pivotable cage elements and/or the restricted working conditions.

Therefore, the inventors of the present invention further found that working with the pivotably semi-cylindrical cage elements may be further improved by introducing an integrated cage opening assistant. This integrated cage opening assistant may assist in opening of the cage by handling and controlling the swing of the pivotably semi-cylindrical cage elements around the pivotably connection; it may secure the pivotably semi-cylindrical cage elements allowing free and safe working environment with the maintenance or the change of wear parts; and the cage opening assistant may assist in closing the cage by controlling the swing of the pivotably semi-cylindrical cage elements around the pivotably connection.

The use of a cage opening assistant may allow the use of pivotably semi-cylindrical elements having larger longitudinal sizes without it becomes unmanageable to the person performing the maintenance or changing the inlays. Thus, the cage opening assistant may make inspection and maintenance of the cage and the screw, as well as changing of inlays, even easier and quicker, even when working with large cage elements, and may reduce the risk of workers being injured, as the cage opening assistant may secure the pivotably semi-cylindrical elements.

By using the pivotably semi-cylindrical cage elements and the cage opening assistant disassembling of the screw press may be reduced or even avoided because the combination of pivotably semi-cylindrical cage elements and the cage opening assistant may opening of the vital parts of the screw press (rather than removing) providing easy and quick access to the essential parts of the screw press, in an easy, fast and safe way.

The term “pivotable connection” relates to a rod or point at which the at least two cage elements may be connected and allows the at least two cage elements of the cage may rotate or may swing. The connection of the at least two cage elements may be a direct connection between two cage elements or the connection of the at least two cage elements may be via a beam or a bracket both placed outside the cage and the beam being placed in parallel with the longitudinal direction of the screw, and wherein the bracket may be oriented transversely to the longitudinal direction of the screw.

The pivotable connection between at least two cage elements of the screw press may be provided by a pivoting device provided for holding together the at least two cage elements, such that one element can swing relative to the other.

In an embodiment of the present invention the pivotable connection may be provided with two interlocking leaves, preferably metal leaves, held together by a pin about which the leaves, and thus the cage element, are allowed to pivot or swing.

In a further embodiment of the present invention the cage comprising a perforated cage-wall.

The perforations provided in the cage-wall may preferably be provided as holes going through the cage-wall allowing a fat fraction or an oil fraction to leave the residual fraction obtained from pressing the material to be pressed.

The perforations provided in the cage-wall may also allow collection of the fat fraction or an oil fraction from the material to be pressed.

In an embodiment of the present invention the perforations provided in the cage-wall may be provided as elongated holes of the cage-wall.

The elongated holes may improve cleaning of the cage of the screw press improving the productivity of the screw press.

In an embodiment of the present invention the cage-wall may comprise a first flange and a second flange combined by curved ribs. The space between the curved ribs may form the elongated holes of the cage-wall.

The distance between the curved ribs may be in the range of 0.1-40 cm, such as in the range of 0.5-30 cm, e.g. in the range of 0.75-25 cm, such as in the range of 1-20 cm, e.g. in the range of 2-15 cm, such as in the range of 3-10 cm, e.g. in the range of 4-8 cm, such as 5-7 cm.

In an embodiment of the present invention the elongated holes of the cage-wall may extend from the first flange to the second flange.

In a further embodiment of the present invention the cage may be provided with a multiplicity of inlays on the inside of the cage.

The inside of the cage may be the space between the cage and the screw. Preferably, the inlays are placed in contact with the inside of the cage towards the screw.

The inlays may be placed perpendicular, or substantially perpendicular, to the direction of the ribs.

The inlays may in a first part of the press chamber only be placed in about the lower half of the press chamber. In the second part of the press chamber the inlays may be placed in the entire circumference of the inside of the cage elements.

In an embodiment of the present invention the first part of the press chamber may represent at most 3 times the distance from the beginning of the press chamber, taken from the starting material inlet, until the end of the starting material inlet, such as at most 2 times, e.g. at most 1 time. The second part of the press chamber may represent the remaining part of the press chamber, Preferably, about 1 time the distance from the beginning of the press chamber, taken from the starting material inlet, until the end of the starting material inlet.

The cage opening assistant may be an integrated part of the screw press. Preferably the cage opening assistant may be located inside a chassis of the screw press.

In an embodiment of the present invention the cage opening assistant may be fixed to at least one of the at least two cage elements.

In yet an embodiment of the present invention the cage opening assistant may be releasable attached to at least one of the at least two cage elements.

By being releasable attached it may be possible to attach one end of the cage opening assistant to the at least one of the at least two cage elements when the at least one of the at least two cage elements is to be opened to provide access to the press chamber and the screw.

In an embodiment of the present invention the cage opening assistant may be attached to at least one cage element.

Preferably, the cage open assistant may comprise a wire comprising a first end and a second end, wherein first end of the wire is connected to a winch; and wherein the second end of the wire is connected to a first fastening means.

In an embodiment of the present invention the cage open assistant comprises a wire comprising a first end and a second end.

Preferably, the first end of the wire may be connected to a winch.

Preferably, the second end of the wire may be connected to a first fastening means.

In an embodiment of the present invention, the first fastening means may be a hook, a carabiner or a shackle.

The cage elements may be provided with one or more second fastening means.

In an embodiment of the present invention the second fastening means may be placed on the second flange. Preferably, second fastening means may be placed on the upper most surface of the second flange of the cage element, before opening the cage.

In an embodiment of the present invention the second flange of the cage element may be located vertically, or substantially vertically, above the first flange of the cage element, when placed inside the screw press.

In an embodiment of the present invention, the second fastening means may be a ring; a carabiner; a shackle; or a hole made in the second flange of the cage element.

The first fastening means (e.g. provided as a hook, a carabiner or a shackle) may interact with and are fixed to the second fastening means (e.g. provided as a ring; a carabiner; a shackle; or a hole made in the second flange of the cage element).

In an embodiment of the present invention the cage open assistant may include a wire attached in one end to a winch which may be powered by an electrical motor, and in the other end of the wire a first fastening means (e.g. provided as a hook, a carabiner or a shackle) may be provided.

The inventors of the present invention found that one advantages of the present invention may be that the cage open assistant as described herein allowed the use of a single wire (including a single winch, a single electrical motor, and a single first fastening means (e.g. provided as a hook, a carabiner or a shackle) may be sufficient to handle (opening and closing) more than one cage element, e.g. both the semi-cylindrical cage elements, such as the first semi-cylindrical cage element and the second semi-cylindrical cage element.

The first fastening means (e.g. provided as a hook, a carabiner or a shackle) may be releasable attached to the second fastening means (e.g. provided as a ring; a carabiner; a shackle; or a hole made in the second flange of the cage element. are provided by means

By being releasable attached the first fastening means may only be attached to the second fastening means of the cage element when used and/or the first fastening means may initially be attached to one second fastening means of a first cage element and when the first cage element has been closed the first fastening means may be moved to the second fastening means of a second cage element. When the second cage element has been closed the first fastening means may be in a neutral position—where the first fastening means is not attached to any second fastening means.

In an embodiment of the present invention wherein the length of the wire (between the winch and the first fastening means) may be controlled by winding the wire onto the winch.

Preferably, the winch may be powered by an electric motor.

In an embodiment of the present invention the winch may be attached to the beam and/or bracket placed above the cage.

The winch may be attached to the beam and/or bracket placed above the cage but inside the chassis of the screw press.

In a preferred embodiment of the present invention the screw press comprises at least 2 beams above the press chamber. Preferably the at least 2 beams may be placed centrally over the screw press centre—the centreline of the cage.

A preferred embodiment of the present invention relates to the use of the screw press according to the present invention, for the separation of a liquid from a solid of a starting material.

The liquid removed may be an aqueous liquid, e.g. water, as it may be relevant to reduce the water content of a product before drying and because it may be desirable to collect the liquid material as a separate fraction as an added value product.

The liquid may also be an aqueous liquid comprising high value products, like proteins, enzymes, peptides, nucleotides, oligonucleotides or other relevant products.

The liquid may also be an oil or a fat product, where preferably a dried starting material may be subjected to pressing, resulting in a fat/oil fraction and a “de-fatted” solid fraction. In an embodiment of the present invention wherein the starting material may be obtained from the rendering industry.

Rendering is a process that converts waste animal tissue into stable, usable materials and starting materials obtained from the rendering industry may refer to any processing of animal products into more useful materials, or, more narrowly, to the rendering of whole animal fatty tissue into purified fats like lard or tallow, or oils. The rendering industry relates to the industrial processing of animal or aquacultural waste products.

Even the present screw press may obviously be used with other starting materials, the invention is provided from the challenges and needs from the rendering industry, but the skilled person would easily understand how to apply the present invention with non-animal products.

In an embodiment of the present invention the starting material may be selected from feather, bone, meat, fish, larvae, and/or a plants (like soy, kokus, palm, nuts sunflower).

A preferred embodiment of the present invention relates to a method of inspecting the screw press according to the present invention, the method comprising the steps of:

(i) removing a first cassis side;

(ii) attaching a first fastening means of a cage open assistant to a second fastening means of a cage element;

(iii) activating the cage open assistant opening the cage element providing access to a press chamber and a screw of the screw press;

(iv) subjecting the cage to the required maintenance; and

(v) activating the cage open assistant and closing the cage element.

(vi) optionally, repeating steps (i)-(v) with a further cage element.

Preferably, the cage open assistant may be fully integrated into the screw press.

The cage open assistant may be fully integrated in the screw press and preferably, the cage open assistant may be fully integrated in the chassis of the screw press.

When activating the cage open assistant, the cage element may be opened or removed completely from the screw press.

In an embodiment of the present invention the cage open assistant may preferably be used for opening both sides of a cage comprising two cage elements. Thus, one cage open assistant is used for handling two (both) sides of the screw press and the cage elements.

It should be noted that embodiments and features described in the context of one of the aspects of the present invention also apply to the other aspects of the invention.

The invention will now be described in further details in the following non-limiting description of the figures.

### DETAILED DESCRIPTION OF THE FIGURES

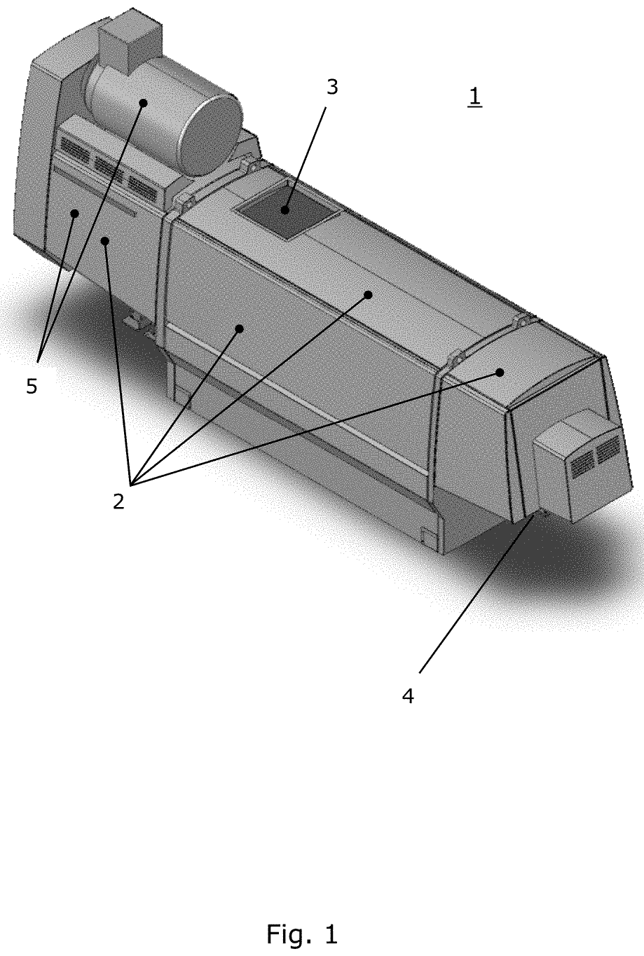

FIG. 1 describes a screw press (1) comprising a chassis (2) covering the screw press (1). On the top of the screw press (1) a starting material inlet (3) is provided where a starting material to be pressed may be introduced into the press chamber (not shown) of the screw press (1).

The starting material to be pressed may be any material from which a liquid material may be separated from a solid material. The liquid material may be an aqueous material, e.g. water, as it may be relevant to reduce the water content of a product before drying to reduce the energy consumption during drying or it may be desirable to collect the liquid material as a separate fraction as an added value product. Added value products may include isolated fractions comprising increased concentration of high value products, like proteins, enzymes, peptides, nucleotides, oligonucleotides or other relevant products. Other added value products of the liquid material may be an oil or a fat product, where the starting material preferably may be a dried starting material, which may be subjected to pressing, resulting in a fat/oil fraction and a “de-fatted” solid fraction.

Preferred starting material may be obtained from the rendering industry. Such material obtained from the rendering industry may be selected from feather, bone, meat, fish, larvae, and/or a plants (like soy, kokus, palm, nuts sunflower).

During operation the starting material may be introduced into the starting material inlet (3) and the starting material is transported through the press chamber of the screw press (not shown) towards the outlet of the solid material (4), by a rotatable shaft (not shown) provided on the outside with a helical structure (not shown). The rotatable shaft (not shown) may be powered by a driving unit (5), which may preferably include an electrical motor.

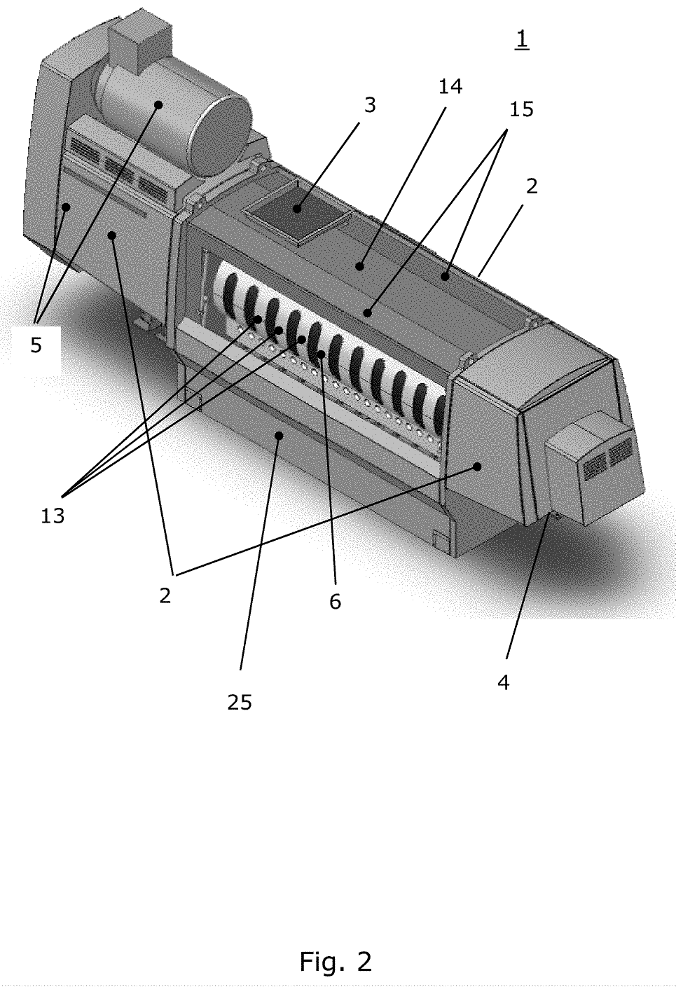

FIG. 2 describes the screw press (1) as described above regarding FIG. 1 where the chassis (2) covering the screw press (1) has been removed from the top of the screw press and from one side of the screw press. The screw press (1) of FIG. 2 shows a starting material inlet (3) provided for introduction of a starting material to be pressed into the press chamber (not shown) of the screw press (1).

FIG. 2 further show a support device (14) placed around a cage (6), which supporting device may support the screw press (1) to the floor. This supporting device (14) may preferably be surrounded by or packed in a chassis (2). The supportive device (14) may comprise at least one upper beam (15)—FIG. 2 shows two upper beams (15), used to support the screw press (1). The cage (6) encircles the press chamber (not shown) and the screw comprising the rotatable shaft (9—not shown in this figure) having an outer surface formed with a helical structure (10—not shown in this figure). The cage (6) is provided with ribs (13), and the space between the ribs (13) provides an open space or an elongated hole of the cage-wall, allowing the liquid pressed from the starting material to filter through and into a collection tank (25) below the cage (6).

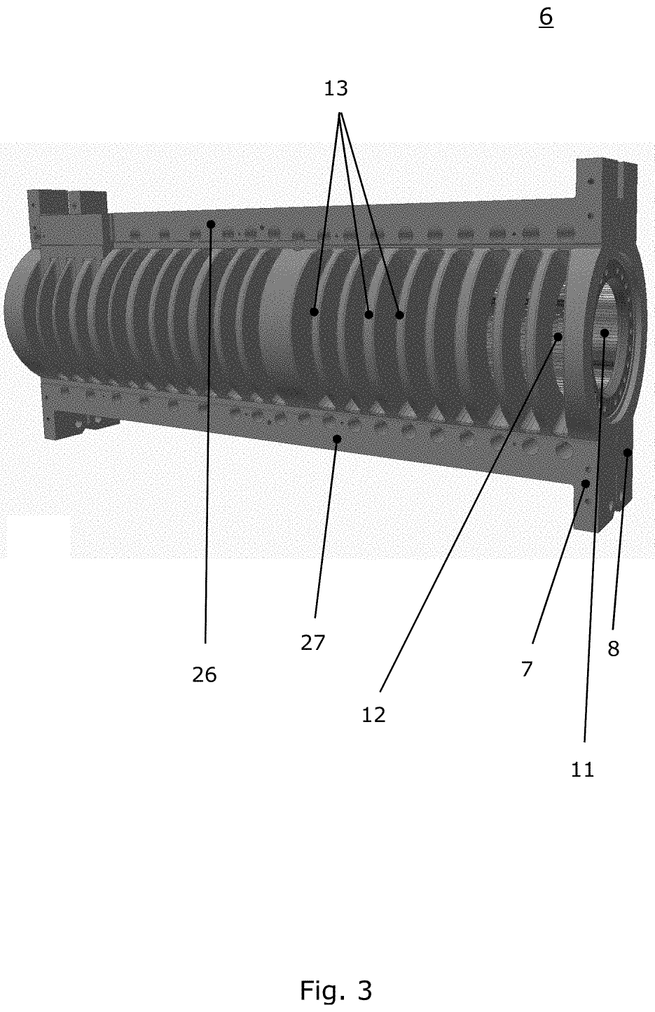

FIG. 3 shows a cage (6) comprising a first cage element (7) and a second cage element (8). The first cage element (7) and the second cage element (8) are fixed to each other and forms a press chamber (11). Each of the cage elements (the first cage element (7) and the second cage element (8)) comprise a first flange of the cage element (26) and a second flange of the cage element (27) which are connected via the ribs (13). The second flange (26) of the first cage element (7) and the second flange (26) of the second cage element (8) may be fixed together either directly to each other or indirectly, e.g. via a bracket (not shown). The first flange (27) of the first cage element (7) and the first flange (27) of the second cage element (8) may be fixed together either directly to each other or indirectly, e.g. via a hinge (not shown).

The cage (6) is on the inside of the first cage element (7) and the second cage element (8) provided with a multiplicity of inlays (12). The inlays (12) are placed with a small distance apart providing a small opening between the multiple inlays (12), preferably the opening between the inleys (12) may be less than 2 mm, such as less than 1.5 mm, e.g. less than 1 mm, such as less than 0.75 mm, e.g. less than 0.5 mm, such as less than 0.25 mm, e.g. less than 0.1 mm, such as less than 0.05 mm, e.g. less than 0.01 mm, such as less than 0.005 mm. This opening between the inleys (12) allows the liquid pressed from the starting material to pass but retaining the solid material and the fines in the press chamber.

The cage (6) in fig.3 comprises several ribs (13) where the space between the ribs (13) provides an open space or an elongated hole of the cage-wall, allowing the liquid pressed from the starting material through the multiplicity of inlays (12) as a filter through the cage (6) and into a collection tank (25—not shown in this figure) below the cage (6).

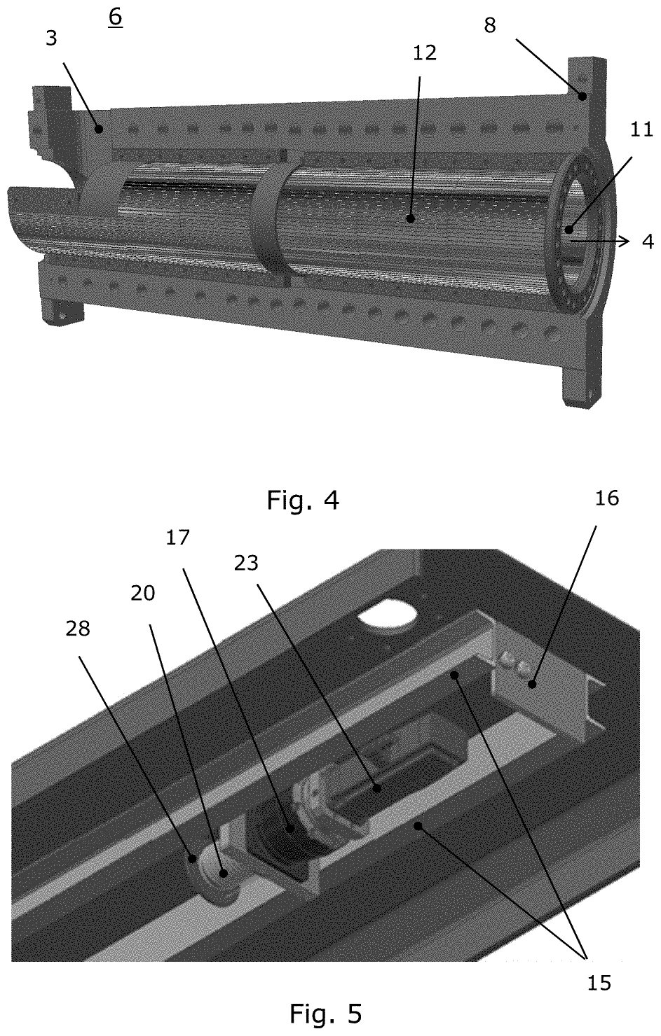

FIG. 4 also shows a cage (6) as described in above in respect of FIG. 3 and comprises a second cage element (8) but the first cage element (7 — not shown in this figure) is removed to clearly illustrate the construction of the multiplicity of inlays (12) which goes along in the entire length of the press chamber (11) of the cage (6).

The inlays (12) in FIG. 4 are placed with a small distance apart providing a small opening between the multiple inlays (12), preferably the opening between the inleys (12) may be less than 2 mm, such as less than 1.5 mm, e.g. less than 1 mm, such as less than 0.75 mm, e.g. less than 0.5 mm, such as less than 0.25 mm, e.g. less than 0.1 mm, such as less than 0.05 mm, e.g. less than 0.01 mm, such as less than 0.005 mm. This opening between the inlays (12) allow the liquid pressed from the starting material to pass but retaining the solid material and the fines in the press chamber. The inlays (12) are in the first part of the press chamber (11) only placed in about the lower half of the press chamber. In the second part of the press chamber (11) the inlays (12) are in the entire circumference of the inside of the cage elements (7/8). Preferably, the first part of the press chamber (11) represents at most 3 times the distance from the beginning of the press chamber (11), taken from the starting material inlet (3), until the end of the starting material inlet (3), such as at most 2 times, e.g. at most 1 time. The second part of the press chamber (11) represents the remaining part of the press chamber (11), Preferably, about 1 time the distance from the beginning of the press chamber (11), taken from the starting material inlet (3), until the end of the starting material inlet (3).

At the starting material inlet (3) the inlays (12) may only be present at the lower half of the press chamber (11) since the pressure at this end lower allowing the liquid pressed from the starting material to pass at reduced pressure, even mainly by gravity, and the rotatable shaft with the helical structure forces the starting material to be moved through the press chamber (11) increasing the pressure on the starting material as the starting material moves from the starting material inlet (3) to the outlet of the solid material (4).

FIG. 5 shows a cage open assistant (17) comprising a wire (20) powered by an electrical motor (23). The cage open assistant (17) may comprise a wire (20) comprising a first end and a second end, wherein first end of the wire (20) is connected to a winch (28); and wherein the second end of the wire is connected to a first fastening means (not shown in FIG. 5). The winch (28) may be attached to the beams (15) placed above the cage, alternatively or in addition the winch (28) may be attached to the bracket (16) placed above the cage (6—not shown in this figure). The winch (28) may be attached to the beams (15) and/or the bracket (16) inside the chassis (not shown in this figure) of the screw press (not shown in this figure), and thus, the cage open assistant (17) and the winch (28) may constitute an integrated part of the screw press.

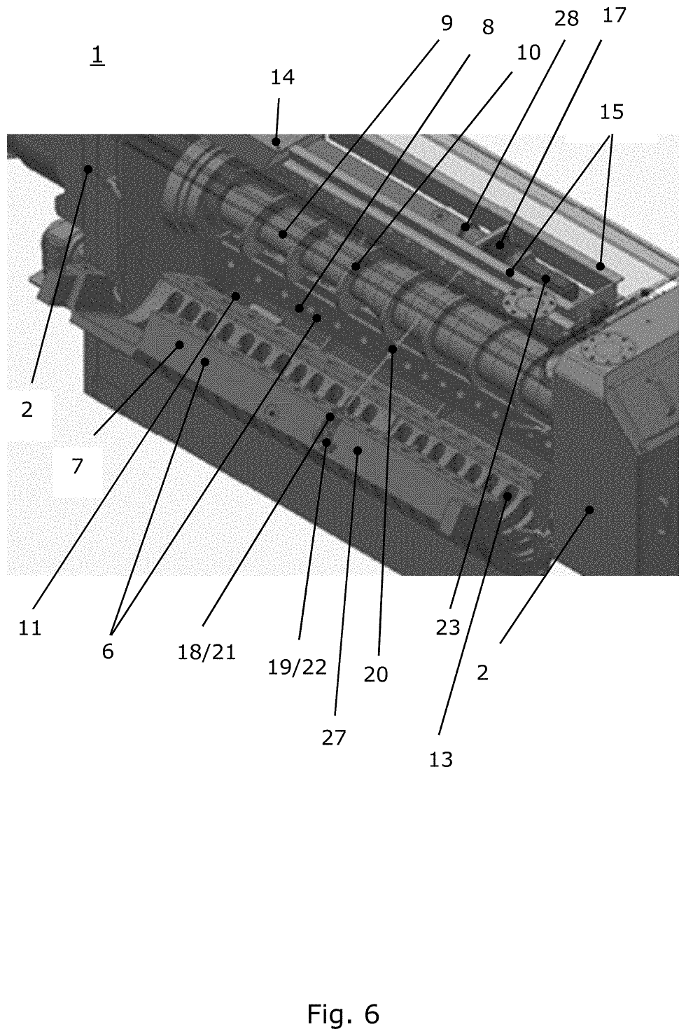

FIG. 6 shows a screw press (1) comprising a chassis (2) covering the screw press (1), where the chassis (2) covering the screw press (1) has been removed from the top of the screw press and from one side of the screw press demonstrating a support device (14) placed around a cage (6), which supporting device may support the screw press (1) to the floor. This supporting device (14) may preferably be surrounded by or packed in the chassis (2). The supportive device (14) may comprise two upper beams (15), used to support the screw press (1).

Between the two beams (15) shown in FIG. 6 a cage open assistant (17) has been provided. The cage open assistant (17) comprising a wire (20) powered by an electrical motor (23). The cage open assistant (17) may comprise a wire (20) comprising a first end and a second end, wherein first end of the wire (20) is connected to a winch (28); and wherein the second end of the wire is connected to a first fastening means (18). The winch (28) may be attached to the beams (15) placed above the cage, alternatively or in addition the winch (28) may be attached to a bracket placed above the cage (6). The winch (28) may be attached to the beams (15) and/or the bracket inside the chassis (2) of the screw press (1), and thus, the cage open assistant (17) and the winch (28) may constitute an integrated part of the screw press. The first fastening means (18) may be provided as a hook (21) and the hook (21) may be attached to a second fastening means (19) provided in FIG. 6, in the form of a ring (22). The second fastening means (19) may be placed on the second flange of the cage element (27). Preferably, the second fastening means (19) may be placed on the upper most surface of the second flange of the cage element (27) and may be used for opening and closing the first cage element (7).

The first fastening means (18), e.g. provided as a hook, a carabiner or a shackle, may be releasable attached to the second fastening means (19), e.g. provided as a ring; a carabiner; a shackle; or a hole made in the second flange of the cage element. By being releasable attached the first attachment means (18) may initially be attached to the second fastening means (19) of a first cage element (7) and when the first cage element (7) has been closed the first fastening means (18) may be moved to the second fastening means (19) of a second cage element (8). When the second cage element (8) has been closed the first fastening means (18) may be in a neutral position — where the first fastening means (18) is not attached to any second fastening means (19).

The cage (6) encircles the press chamber (11) and the screw comprising the rotatable shaft (9) having an outer surface formed with a helical structure (10). The cage (6) is provided with ribs (13), and the space between the ribs (13) provides an open space or an elongated hole of the cage-wall, allowing the liquid pressed from the starting material to filter through and into a collection tank (not shown in this figure) below the cage (6).

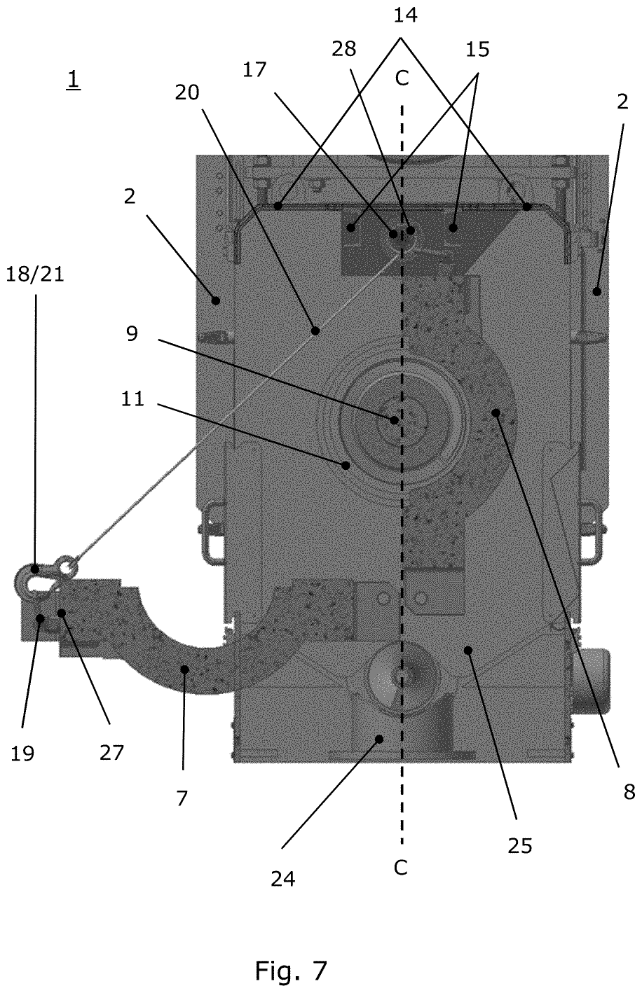

FIG. 7 show an end-view of the screw press (1) comprising a chassis (2). Underneath the chassis (2) a supporting device (14) comprising two beams (15) and a bracket may be provided. The two beams (15) are centrally placed above the press chamber (11) along a centreline (C) of the cage (and the rotatable shaft (9). A cage open assistant (17) is provided between the two beams (15). The cage open assistant (17) comprises a wire (20) having in a first end connected to a winch (28) and a second end of the wire connected to a first fastening means (18), provided as a hook (21). The first fastening means (18) may be connected to a second fastening means (19) placed on the second flange of the cage element (27). Preferably, the second fastening means (19) may be placed on the upper most surface of the second flange of the cage element (27) and has been used for opening the first cage element (7) e.g. for maintenance. When the first cage element (7) has been closed the first fastening means (18) may be released from the second fastening means (19) of the first cage element (7) and attached to a second fastening means (19) on the second cage element (8), and the second cage element (8) may be opened and closed accordingly.

During operation the starting material pressed may excrete a liquid material, e.g. a fat or an oil, which may filter into the collection tank (25) below the cage (6) and to the outlet of the liquid (24).

### REFERENCES

(1): screw press

(2): chassis of the screw press

(3): starting material inlet

(4): outlet of solid material

(5): driving unit

(6): cage

(7): first cage element

(8): second cage element

(9): rotatable shaft

(10): helical structure

(11): press chamber

(12): inlays

(13): ribs

(14): supporting device

(15): beam

(16): bracket

(17): cage open assistant

(18): first fastening means

(19): second fastening means

(20): wire

(21): hook

(22): ring

(23): electrical motor

(24): outlet of the liquid

(25): collection tank

(26): first flange of the cage element

(27): second flange of the cage element

(28): winch

1. A screw press (1) comprising a press chamber (11) comprising a screw and surrounded by a cage (6), wherein the screw comprising a rotatable shaft (9) having a helical structure (10) on the outside of the rotatable shaft (9), and wherein the cage (6) is provided with at least two cage elements (7/8), wherein at least one cage element of the at least two cage elements (7/8) comprises a pivotable connection allowing the at least one cage element to pivot, wherein the screw press (1) is provided with a cage open assistant (17), assisting the at least one cage element (7/8) to pivot.

2. The screw press (1) according to claim 1, wherein the cage comprises two cage elements (7/8).

3. The screw press (1) according to claim 2, wherein the two cage elements (7/8) comprise two semi-cylindrical cage elements.

4. The screw press (1) according to claim 1, wherein the cage comprising a perforated cage-wall.

5. The screw press (1) according to claim 1, wherein the cage is provided with a multiplicity of inlays (12) on the inside of the cage (6).

6. The screw press (1) according to claim 1, wherein the cage open assistant (17) comprises a wire (20) comprising a first end and a second end, wherein first end of the wire (20) is connected to a winch (28); and wherein the second end of the wire is connected to a first fastening means (18).

7. The screw press (1) according to claim 1, wherein the winch (28) may be attached to a beam (15) and/or bracket (16) placed above the cage (6).

8. Use of the screw press (1) according to claim 1, characterized in that the screw press (1) is used for the separation of a liquid from a solid of a starting material.

9. A method of inspecting the screw press (1) according to claim 1, the method comprising the steps of:
(i) removing a first chassis side (2);
(ii) attaching a first fastening means (18) of a cage open assistant (17) to a second fastening means (19) of a cage element (7/8);
(iii) activating the cage open assistant (17) opening the cage element (7/8) providing access to a press chamber (11) and a screw of the screw press (1);
(iv) subjecting the cage to the required maintenance; and
(v) activating the cage open assistant (17) and closing the cage element (7/8).
(vi) optionally, repeating steps (i)-(v) with a further cage element (7/8).

10. The method according to claim 9, wherein the cage open assistant (17) is fully integrated into the screw press (1).
